(19) United States
(12) Patent Application Publication
(10) Pub. No.: US 2008/0210639 A1
(43) Pub. Date: Sep. 4, 2008

(54) ON-BOARD SYSTEM AND METHOD FOR TREATING A BODY OF WATER

(76) Inventor: Keith Leistner, Whiteland, IN (US)

Correspondence Address: BOTKIN & HALL, LLP, 105 E. JEFFERSON BLVD., SUITE 400, SOUTH BEND, IN, 46601, US

(21) Appl. No.: 12/040,138

(22) Filed: Feb. 29, 2008

Related U.S. Application Data
(60) Provisional application No. 60/904,664, filed on Mar. 2, 2007.

(51) Int. Cl. C02F 1/68

(52) U.S. Cl. 210/747; 210/206; 210/205; 210/170.09; 210/170.11; 210/749

(57) ABSTRACT

An on-board system and method for treating lakes and ponds with chemicals is disclosed. The system is contained on a watercraft and can operate continuously without interruption. Water is pumped on board from the pond or lake and strained. Treatment product is introduced into the flow stream by a controlled mixing means to form a prescribed treatment solution, which is then delivered into the pond or lake. The mixing means includes a Y fitting coupled upstream from the pump. In another application, an inductor is provided downstream from the pump for mixing solid product with the flow stream to form a treatment mixture. The solution or mixture, whichever the case may be, is discharged into the pond or lake via a boom and/or a hand line outfitted with a nozzle(s). A conduit system with pump(s), valves, and manifolds connects the intake and the discharge ends of the system. The system is adaptable to apply any phase of treatment product to most any size of water body, including retention ponds, lakes, streams and so forth. In its smallest set up, the system may be contained on a frame as a single unit for converting smaller watercraft to temporary water treatment vehicles.

### CROSS REFERENCE TO RELATED APPLICATIONS

This application claims the benefit of U.S. Provisional Application No. 60/904,664, filed Mar. 2, 2007, the disclosure of which is hereby incorporated by reference.

### BACKGROUND OF THE INVENTION

1. Field of the Invention

This invention relates to systems and methods for treating a body of water to control the proliferation of plants and other organisms and, more particularly, to an on-board system and method for treating a body of water.

2. Description of the Background of the Invention

Retention ponds and other bodies of water often produce unacceptable amounts of plant growth, including algae. If left untreated, plant canopies can block needed sunlight into the water. Ponds and lakes can become unsightly and infested with unwanted insects as a result. In addition to algaecide and herbicide, ponds and lakes may also be treated with myriad substances to control populations of fish and other biological organisms.

Treatments are typically applied by hand and are not particularly efficient because they rely upon wind and wave action to diffuse and deliver the product to the plant. The futility of many of these chemical applications is also due to the short shelf life of the applied substance. Many herbicides, algaecides, and treatment substances breakdown before reaching the plant or other treatment zone.

Some treatment methods include rotary spreaders for dispersing solids, spot sprayers for liquids, and a collection of other sprayers typically used in terrestrial applications. This equipment is unsuitable for pond and lake applications and usually has flow rates that are less than ten gallons per minute (gpm). Using guesswork, operators typically spray small volumes of product mixtures that are too highly concentrated onto the pond's surface, and as a result, break the laws governing minimum dilution rates specified by the herbicide/algaecide manufacturers. Some terrestrial pumps have higher flow rates, but their size, weight, and cost make them economically unfeasible or otherwise undesirable for treating ponds and lakes. Mixing tanks, product supply, and equipment, loaded on-board smaller crafts, for example, can cause the boat to drag bottom while larger tanks and loads used for lake treatments cause the boat to violate U.S. Coast Guard (USCG) boat hull weight ratings. Another problem deals simply with surface area covered. Intuitively, when the manufacturer's recommended treatment is one quart of solution per surface acre of water, for example, the most efficient treatment is achieved by blanketing the water acre with treatment solution, not spot spraying.

Other problems become apparent when it's desirable to use water as a carrier to spread solid granular treatment product. Terrestrial systems are useless for treating ponds and lakes. Agricultural or terrestrial applications that mix solid treatment product with water direct the mixture to a tank or other open, unobstructed device before discharge. The product typically precipitates to the bottom of the tank, which negatively affects treatment results. This is not acceptable in treating ponds and lakes. Solid treatment products, such as Bayluscide® for example, used to control sea lamprey in parts of the Great Lakes, are time-release granular particles; they must reach a target depth and/or site in the water before dissolving to have optimal treatment effect. Using current methods available, after the product is spread, wind and resulting wave action tend to carry the treatment product off the target site.

Solids also sometimes cause cavitation in flowable systems, and some substances, like Bayluscide®, are also toxic to humans. If any backpressure such as a nozzle or any restriction is placed on the discharge of the inductor, the water and product tend to back up into the inductor tank and cause harm to operators. Air is also oftentimes introduced as the water and product come together in the inductor. If the material is open discharged, air is not a problem. In pond and lake treatment systems, however, open discharge is usually not preferred.

The following shortcomings in pond and lake treatment systems have been observed: USCG boat hull weight limitations consistently violated; inefficient delivery and coverage of treatment products onto or within the water, coverage has been spotty, not blanketed; hand disbursement of solids with subsequent reliance on wind and wave action for dilution/dispersion; environmental breakdown of product before reaching treatment area; minimum dilution ratio of product to water, which is desirable for economic and environmental reasons, cannot be achieved; and, finally, cavitation, backup and resulting human exposure to solid toxic product.

Accordingly, there remains a need for an improved system for treating a body of water, which system is capable of, among other things, blanketing a pond or lake with a prescribed amount of treatment product, whether liquid, powder, or solid, without the use of heavy pumps, mixing tanks, and other clumsy on-board paraphernalia that cause violation of boat hull weight regulations.

### SUMMARY OF THE INVENTION

A system for treating a body of water includes a pump for pumping water from the body of water and into the system. The pump has a pump intake and a pump discharge. The system includes a strainer effective for cleaning water passing through the pump, and mixing means effective for mixing treatment product with the water to form a treatment solution. A delivery means is also provided for delivering the treatment solution from the pump discharge onto the surface or within the body of water, and for controlling the rate of flow of the treatment solution upon discharge.

The pump may be contained on a water craft and effective for discharging the solution at a rate of between one gallon per minute and 200 gallons per minute.

The delivery means may include at least one hand line.

The delivery means may include at least one boom line.

In one aspect of the invention, the system includes a fill tank, and the pump, the tank, and the mixing means are contained as a single unit on a watercraft.

In another aspect, a method of treating a body of water includes: (i) providing a flow of clean water by pumping water from the body of water through a strainer by using a pump that has a pump intake; (ii) adding treatment product to the flow of water by using a Y fitting connected to a suction stream upstream from the pump intake to form a treatment solution; (iii) delivering the treatment solution onto the surface or within the body of water; and, (iv) controlling the rate of flow of the treatment solution onto the surface or within said body of water by using a hand line, a boom line, or a drop line.

In yet another aspect, instead of using a Y fitting connected upstream from the pump, the treatment product is added to the flow of water by using an inductor assembly to form a mixture.

The inductor assembly may include venturi means, and the inductor assembly may be downstream of the pump.

One object of the invention is to provide an improved system for treating a body of water, which system is capable of, among other things, blanketing a pond or lake with a prescribed amount of treatment product, whether liquid, powder, or solid, without the use of heavy pumps, mixing tanks, and other clumsy on-board paraphernalia that cause violation of boat hull weight regulations. Related objects and advantages of the invention will be apparent from the following description.

### BRIEF DESCRIPTION OF THE DRAWINGS

FIG. 1 is a top schematic view of an embodiment of the system of the invention with the outline of a watercraft shown in phantom lines.

FIG. 1B is an elevated perspective view of an embodiment of the system of the invention shown assembled on a boat.

FIG. 2 is a top schematic view of a smaller version of the system showing the fill tank, Y fitting, and pump mounted on a frame as a single unit.

FIG. 3 is a top schematic view of another embodiment of the system of the invention especially useful for discharging a mixture of water and dry product showing the inductor assembly connected downstream of the first pump.

### DETAILED DESCRIPTION OF INVENTION

Forming and Applying a Treatment Solution

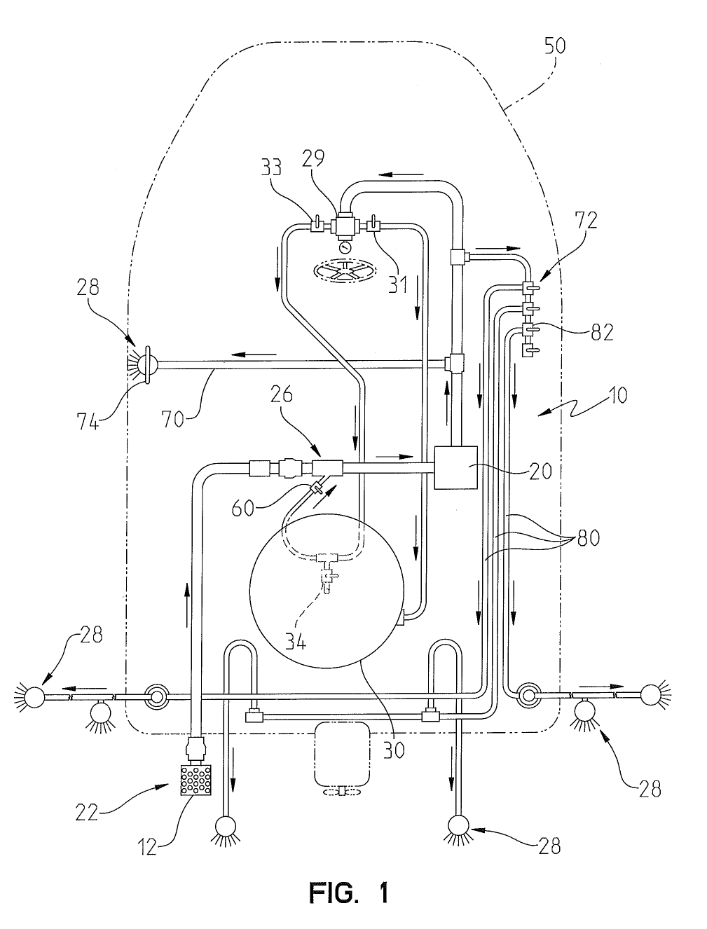

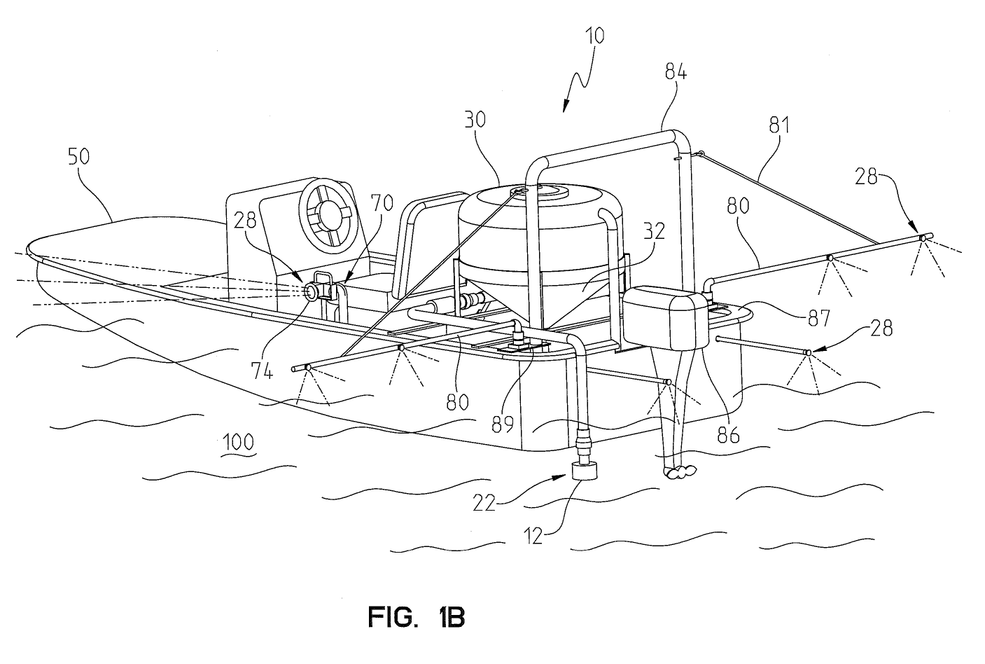

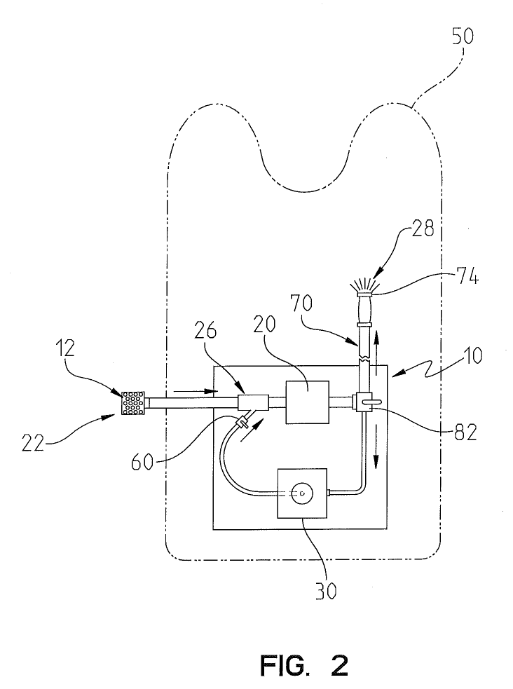

Referring to the examples illustrated in FIGS. 1-2, to operate the system, water is drawn into the watercraft or boat 50 through the water intake 22 that extends down into the water over the side of the boat 50. The water is cleaned by a strainer 12. Preferably, a strainer 12 is placed on the end of the hose, as shown in FIG. 1. Downstream of the strainer is a check valve that is used to prevent the pump 20 from loosing prime. As the water flows toward the pump 20, it travels through a second strainer (not shown) that removes smaller particles, such as sand, rocks, plant material. In a preferred embodiment, the strainer(s) is effective for removing all particles one-half inches (0.50 in.) or larger from the water passing through the pump. In a more preferred embodiment, the strainer(s) is effective for removing 95% of all particles one-quarter inches (0.25 in.) or larger from the water passing through the pump. In the most preferred embodiment, the strainer(s) is effective for removing 100% of all particles one-sixteenth inches (0.0625 in.) or larger from the water passing through the pump 20.

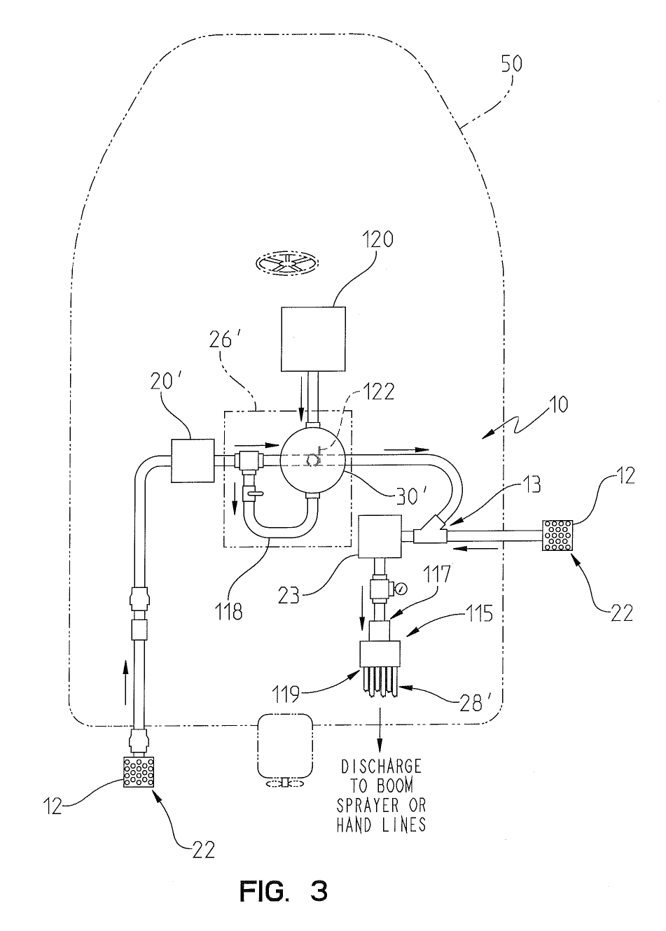

As shown schematically, in FIGS. 1 and 2, after leaving the second strainer the water flows through a stainless steel Y fitting 26, which is where the product is introduced into the flow stream. The system 10 is configured for product of most any type, including but not limited to liquid, solid, and powder form. The following paragraphs detail the mixing and processing of a liquid and/or powder treatment product to form a solution. Once mixed, the solution is fed into the pump intake where, as it flows through, it may be more thoroughly mixed with the water to create a treatment solution. Depending upon the particular treatment scheme and product desired, the treatment solution may comprise a homogeneous solution containing dissolved product, partially dissolved product, or suspended product, in which case the water serves as a carrier to simply transport the solid product, which process will be described later in conjunction with the embodiment represented by FIG. 3. Downstream, the solution enters a discharge header.

The header contains a port for a hand line 70, which at the time of this writing includes a 1.5 inch hose. On the end of the hose is a 35-gallon per minute (gpm), 65-gpm, or 95-gpm variable pattern nozzle 74. The nozzle is used to treat areas that cannot be covered with the booms 80 or to aggressively apply treatment to a spot area.

The discharge header 29 includes a second port for directing water to the fill tank 30. The water flow is split and has two valves 31, 33 that feed the tank fill. The first valve 31 is located near the top of the tank 30. The top fill valve 31 is used when introducing water soluble solids such as copper sulfate. In one embodiment, the bottom 32 of the tank is shaped like an inverted cone. The velocity of the water flow entering the top of the tank is increased by use of a nozzle so that the water is made to flow in a circular pattern within the fill tank, which stirs the material without the need for additional agitation.

The second fill valve 33 directs water into the bottom of the tank. This is important because some products produce foam when mixed aggressively as some treatment products require. By filling from the bottom, the treatment product is mixed with water and no foam is produced. The bottom fill, which includes a shut off valve 34, may be used as a means of flushing out any product build up in the line upstream that feeds the solution into the suction of the pump. As part of the same header used to bottom fill the tank, a second valve 60 is included and used as a regulating valve to control the amount of material introduced into the suction of the pump through the Y fitting 26.

A third port exiting the pump discharge feeds a valve header 72 used to direct treatment solution to the boom lines or sections 80. In one embodiment, the design of the manifold is such that it may be expanded to accommodate additional feeds to devices facilitating other key operations, such as jug rinsing or simply as a water source. Each boom section 80 has its own valve 82 for individual control.

Mixing and Applying Solid Treatment Product

With reference to the example of FIG. 3, the process for mixing dry product, granular matter for example, that remains suspended in the water of the system 10 of the invention until after it is discharged into the water is described below.

As in the previous examples, water is drawn from the subject lake or pond and into a pump, preferably a centrifugal pump 20′. The water is then discharged from the pump 20′ and into an inductor assembly 26′, which includes a feeder, preferably a hopper/screw feeder assembly, as schematically depicted in FIG. 3, and a tank 30′ positioned below the feeder 120. Between the tank 30′ and the inductor is a shutoff valve 122. The inside of the tank may be partitioned into separate chambers, preferably four, with a common opening near the bottom of the tank 30′ to allow water to come from all four chambers and exit the bottom of the tank. This eliminates the vortex created as the water is drawn out of the bottom of the tank into the inductor. Dry product is introduced into the center of the tank 30′ by way of the hopper and screw feeder 120.

The middle of the flow straightener defines a hollow tube (not shown) that allows the dry product to move towards the bottom of the flow straightener into the common area of the tank 30′ before the product contacts any water and leaves the tank 30′ through the inductor. The inductor assembly 26′ operates along the lines of a venturi. As water flows through the inductor assembly 26′ at the bottom, dry product is introduced from the screw feeder 120 into the tank 30′ at its top.

In one embodiment, the feeder 120 consists of a hopper and houses a screw conveyor at the bottom. The conveyor may be controlled by a variable speed drive unit. The feeder 120 may have a local on/off switch or may be operated and controlled remotely and electrically connected using means known by skilled technicians. The speed of the screw conveyor determines the rate at which the product is fed into the flow stream. The amount of product needed in the system is determined by the speed of the boat, the width of the sprayer path, and the amount of material needed per surface acre of water. Because the mixing is continuous and the product is not routed to a storage tank from which it is later discharged, the product does not settle in a tank. Instead, the product is directly discharged onto or beneath the water's surface via the hand and/or boom lines 70, 80.

To maintain continuity of the process and prevent water and product mixture backup, a pump 23 adds pressure to the mixture. Otherwise, the mixture may cavitate, and the pump may lose its prime. In some of the experimental applications, the pump 23 was not effectively able to drive and discharge the mixture from the spray nozzles 28. Air introduced in the inductor 26′ caused cavitation in the second pump 23. Air may be eliminated by introducing seal water into the four chambers of the inductor tank 30′ via U-shaped conduit 118 schematically depicted in FIG. 3. Seal water is continuously fed into the inductor tank to maintain a level that seals the opening of the inductor from atmosphere. An effective vacuum is created, and the seal water prevents air from entering the liquid stream. The vacuum of the inductor draws the dry material and the seal water out of the inductor tank 30′ where it moves towards the second pump 23.

When the mixture leaves the inductor, it travels toward the intake of the second pump 23. Before entering the second pump, the mixture passes through a Y fitting 13. The Y fitting 13 provides additional makeup water from the pond or lake for the second pump 23 and discharge line(s) 28′ and serves as a relief for the inductor. If the pump 23 shuts off during the process, the mixture will vent to the lake without backing up into the inductor assembly 26′. The pump 23 works to oppose the backpressure created by the spray nozzles or any other restriction. Venting the material back into the lake in the event of pump failure protects the operator(s) from exposure to the material, which in some cases may be toxic.

As the mixture exits the pump 23, it travels to an eccentric chamber 115 where the flow rate and direction of the mixture are optimally controlled. The mixture enters the small end 117 of the eccentric chamber and exits through the large end 119 of the chamber 115 via multiple ports. The chamber 115 preferably includes a generally flat bottom. In one embodiment, the ports are arranged in the same plane at the end of the chamber so the mixture is evenly distributed into each of the ports for discharge by way of the individual spray lines and/or nozzles. The eccentric chamber 115 also decelerates the mixture before it enters each of the ports. This deceleration slows the mixture and helps prevent the product from colliding with the walls, linkages and nozzles before discharge. Some solid treatment products, such as Bayluscide® for example, used to control the sea lamprey in parts of the Great Lakes, are coated with protective layers of material that dissolve after discharge. Violence to the protective coatings exposes the treatment product while it's still in the system. As a result, treatment would not be optimal.

The chamber 115 also ensures that equal amounts of material are distributed into each of the exit ports. In one embodiment, the lines 28′ connected to each of the exit ports are the same length and the nozzle openings the same size so that an equal amount of the mixture is discharged through each exit ports and the mixture is distributed evenly over an applied area. Because the mixture enters the smaller end 117 of the chamber 115 on the flat chamber bottom and thus has an increased flow rate, product does not settle there. The heavier product within the flow stream is also directed in a straight line to the discharge lines 28′.

In another embodiment contemplated for generally smaller applications, all of the valves, the tank, and the pump are mounted to a tank stand as a single unit, as schematically shown in FIG. 2. The tank stand is, in turn, mounted to two rails secured to the bottom of the boat 50. The tank stand is mounted to the rails with six bolts for conveniently removing the tank stand. At strategic locations the hoses are fitted with cam lock fittings so they may be conveniently disconnected to remove and store the tank stand, to winterize the boat and system or to flush and clean the system.

Referring to all of the figures, but emphasizing FIG. 1B, most of the system's components, such as the stand, rails, mounting hardware, fittings, booms, including the support structures for the boom(s), and so forth may be formed from stainless steel or plastic to resist corrosion.

The boom structure includes a stainless steel roll bar 84 mounted at the rear of the boat 50. The roll bar supports the booms 80 and provides access to the outboard 86. The top lip 87 of the boat hull includes a stainless steel plate 89 welded to the roll bar 84. The plate provides an anchor or base for the boom. Each plate includes a bolt-thru threaded tank flange. On the bottom side of the tank flange is a fitting to which a hose is joined for connecting to the boom control valve 82. A swivel joint is located on the top of the tank flange. In the preferred embodiment, solution flows inside the boom structure and thus, the swivel joint allows the boom to be stored and deployed without disassembly. This design reduces overall weight within the boat hull as well.

The boom section is connected to the swivel by using a flange fitting. Preferably, the flange fitting includes two flanges, a gasket, and a clamp. This assembly allows the boom to be rotated 360 degrees for any nozzle angle position thus ensuring complete delivery of solution onto the surface or within the lake or pond 100. In that embodiment, the boom 80 may be employed for surface spray nozzles and then conveniently rotated to a different position to accommodate drop lines for deep water injection.

In one embodiment, the boom section is manufactured using 316 stainless steel 65 thousandths (0.065) inch walled tubing. Fittings are attached to the boom section 80 and welded. The fittings can be fitted with known devices that allow for different treatment solution applications. In a preferred embodiment, the end of the boom is fitted with a fitting that allows for the length of the boom to be extended when conditions necessitate a longer boom. Typically, approximately five to eight feet is used. The boom structure is also designed to be quickly and easily stored and deployed.

In one embodiment, the boom rests in a two-piece saddle (not shown) that has a hand knob to securely hold the boom in the stored position. Loosening the knob and lightly removing the boom from the saddle deploys the boom. Then, a locking pin must be removed from the tube brace. While holding onto the brace, slight rotation of the brace on the main boom pushes the boom away from the boat. Once fully extended, the brace may be lowered into the keeper located on the top portion of the side of the boat. The locking pin is then reinserted, and the boom is ready for operation.

A guy wire 81 attaches from the top of the roll bar 84 to a point just over the midpoint on the boom to provide support while the boom is deployed for spraying. Also, if drop lines are being used, guy wires running from the boom to the front of the boat add support. A rope and pulley assembly preferably connects the intake and the top edge of the boat. The pulley is positioned on the roll bar. The rope and pulley assembly lift the intake from the water for cleaning or to prevent drag in shallow water.

In one embodiment, on a larger boat, the hand line 70 is mounted to the side of the boat on a turret that provides a multi directional rotation of the nozzle, as shown in FIG. 1B. The operator therefore need not become fatigued holding the nozzle. In another embodiment (FIG. 2), on a smaller craft, the tank stand, as indicated above, is modular. Modularity allows for all the system components to be light and easily maneuverable as a single unit. The small boat may thus serve as a recreational craft, for fishing for example, or it may be converted and equipped to treat bodies of water as above-described.

For the purposes of promoting an understanding of the principles of the invention, specific embodiments have been described. It should nevertheless be understood that the description is intended to be illustrative and not restrictive in character, and that no limitation of the scope of the invention is intended. Any alterations and further modifications in the described components, elements, processes, or devices, and any further applications of the principles of the invention as described herein, are contemplated as would normally occur to one skilled in the art to which the invention relates.

What is claimed is:

1. A system for treating a body of water comprising:
a) a pump for pumping water from the body of water and into said system, said pump having a pump intake and a pump discharge;
b) a strainer effective for cleaning water passing through the pump;
c) mixing means effective for mixing treatment product with the water to form a treatment solution; and,
d) delivery means for delivering the treatment solution from the pump discharge onto the surface or within the body of water, and for controlling the rate of flow of said treatment solution onto the surface or within said body of water.

2. A system according to claim 1 wherein said pump is effective for discharging said solution at a rate of between one gallon per minute and 200 gallons per minute.

3. A system according to claim 1 wherein said pump is contained on a watercraft.

4. A system according to claim 1, wherein said delivery means includes at least one hand line.

5. A system according to claim 1, wherein said delivery means includes at least one boom line.

6. A system according to claim 1, wherein said system includes a fill tank with a bottom in the shape of an inverted cone.

7. A system according to claim 6 wherein said tank is contained on a watercraft.

8. A system according to claim 1 wherein said mixing means is contained on a watercraft.

9. A system according to claim 1 wherein said pump, a fill tank, and said mixing means are contained as a single unit on a watercraft.

10. A system according to claim 1 wherein said strainer is effective for removing 95% of all particles 0.25 inches or larger from the water passing through the pump.

11. A system according to claim 1 wherein said mixing means includes a tank with a bottom, a lower fill valve is coupled near the bottom of the tank so that water can enter said bottom of said tank, the bottom of the tank is in the shape of an inverted cone for directing the flow of the water so that the system is effective for mixing the treatment product with the water without producing foam.

12. A system according to claim 5, wherein said system includes a valve header for delivering the treatment solution to said boom line.

13. A system according to claim 8, wherein said mixing means includes a regulating valve to control the amount of treatment product mixed with said water to form said treatment solution.

14. A system according to claim 12, wherein said system includes a valve for controlling the flow of the solution through said boom line.

15. A system according to claim 1, wherein an inductor assembly defines said mixing means, and said treatment solution includes solid product suspended in solution and carried through said system by water and discharged onto the surface or within said body of water, said inductor assembly being downstream of said pump.

16. A method for treating a body of water comprising:
a) providing a flow of clean water by pumping water from the body of water through a strainer by using a pump, said pump having a pump intake;
b) adding treatment product to the flow of water by using a Y fitting connected to a suction stream upstream from the pump intake to form a treatment solution;
c) delivering the treatment solution onto the surface or within the body of water; and,
d) controlling the rate of flow of said treatment solution onto the surface or within said body of water by using a hand line, a boom line, or a drop line, said drop line extending below the surface of the body of water.

17. A method according to claim 16 wherein treatment solution is delivered onto the surface or within the body of water at a rate of between one gallon per minute and 200 gallons per minute.

18. A method according to claim 16 wherein said pump is contained on a watercraft.

19. A method according to claim 16, wherein the method includes directing the treatment solution into a fill tank.

20. A method according to claim 16, wherein said strainer is effective for removing 95% of all particles 0.25 inches or larger from the water passing through the pump.

21. A method according to claim 16, wherein said boom line includes a valve for controlling the flow of the solution through said boom line.

22. A method according to claim 16, wherein said method is conducted on a watercraft.

23. A method according to claim 16, wherein, instead of using a Y fitting connected upstream from the pump, the treatment product is added to the flow of water by using an inductor assembly to form a mixture.

24. A method according to claim 23, wherein said inductor assembly is downstream of said pump, said inductor assembly includes venturi means for introducing the treatment product into a flow stream to form a mixture.
